(19) United States
(12) Patent Application Publication
(10) Pub. No.: US 2024/0224367 A1
(43) Pub. Date: Jul. 4, 2024

(54) METHOD AND APPARATUS FOR DYNAMICALLY CHANGING UPLINK CELL IN COMMUNICATION SYSTEM

(71) Applicant: Samsung Electronics Co., Ltd., Gyeonggi-do (KR)

(72) Inventors: Sangkyu BAEK, Gyeonggi-do (KR); Beomsik BAE, Gyeonggi-do (KR)

(21) Appl. No.: 18/557,168

(22) PCT Filed: May 11, 2022
(86) PCT No.: PCT/KR2022/006724

§ 371 Date: Oct. 25, 2023

(30) Foreign Application Priority Data
May 12, 2021 (KR) 10-2021-0061655

(51) Int. Cl. H04W 76/20; H04W 72/1268; H04W 72/21; H04W 72/566

(52) U.S. Cl. CPC H04W 76/20; H04W 72/1268; H04W 72/21; H04W 72/566

(57) ABSTRACT

The disclosure relates to a 5G or 6G communication system for supporting a higher data transmission rate. A method for user equipment according to an embodiment of the present disclosure comprises the steps of: receiving, from a base station, first information indicating activation or deactivation of at least one uplink cell of a first cell group; transmitting, to the base station, second information indicating that the first information has been received; identifying, on the basis of the first information, whether or not, from among the at least one uplink cell, a first uplink cell has been activated; and if the first uplink cell has been activated, carrying out an uplink transmission via the first uplink cell.

### TECHNICAL FIELD

The disclosure relates to operations performed by a user equipment and a base station in a communication system. More specifically, the disclosure relates to a method and an apparatus for dynamically changing an uplink cell (or cell group) in a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands. NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML). AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

A plurality of uplink cells for performing uplink transmission may be configured to the user equipment in a communication system to which the disclosure may be applied. Meanwhile, when a user equipment attempts to perform multiple uplink transmissions simultaneously through multiple uplink cells, a problem may occur in which uplink cell coverage is decreased.

Accordingly, there is a need to devise a method to solve these problems.

### Solution to Problem

According to various embodiments of the disclosure, methods for solving the problem of decreased uplink cell coverage are provided.

A method performed by a user equipment according to an embodiment of the disclosure may include receiving, from a base station, first information indicating activation or deactivation of at least one uplink cell of a first cell group; transmitting, to the base station, second information indicating that the first information is received; identifying, based on the first information, whether a first uplink cell among the at least one uplink cell is activated; and performing an uplink transmission through the first uplink cell when the first uplink cell is activated.

A method performed by a base station according to an embodiment of the disclosure may include transmitting, to a user equipment, first information indicating activation or deactivation of at least one uplink cell of a first cell group; and receiving, from the user equipment, second information indicating that the first information is received, and whether a first uplink cell among the at least one uplink cell is activated is identified based on the first information, and an uplink reception is performed through the first uplink cell when the first uplink cell is activated.

A user equipment according to an embodiment of the disclosure may include a transceiver; and a controller connected to the transceiver, wherein the controller receives, from a base station, first information indicating activation or deactivation of at least one uplink cell of a first cell group, transmits, to the base station, second information indicating that the first information is received, identifies, based on the first information, whether a first uplink cell among the at least one uplink cell is activated, and performs an uplink transmission through the first uplink cell when the first uplink cell is activated.

A base station according to an embodiment of the disclosure may include a transceiver; and a controller connected to the transceiver, wherein the controller transmits, to a user equipment, first information indicating activation or deactivation of at least one uplink cell of a first cell group, and receives, from the user equipment, second information indicating that the first information is received, and whether a first uplink cell among the at least one uplink cell is activated is identified based on the first information, and an uplink reception is performed through the first uplink cell when the first uplink cell is activated.

### Advantageous Effects of Invention

According to various embodiments of the disclosure, a method and an apparatus for dynamically changing an uplink cell (or cell group). According to this, it is possible to achieve the effect of solving the problem of reduced uplink cell coverage.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

The above and other purposes, features, and advantages of the disclosure will be further clarified with reference to the accompanying drawings through the following description of embodiments of the disclosure.

FIG. 1 is a diagram illustrating a base station connection method according to an embodiment of the disclosure.

FIG. 2 is a diagram illustrating an uplink cell switching method according to an embodiment of the disclosure.

FIG. 3 is a diagram illustrating an activation method of an uplink cell according to an embodiment of the disclosure.

FIG. 4 is a diagram illustrating an activation method of an uplink cell according to an embodiment of the disclosure.

FIG. 5 is a diagram illustrating a transmission method between base stations for PUCCH transmission according to an embodiment of the disclosure.

FIG. 6 is a diagram illustrating a prioritization method for uplink transmission according to an embodiment of the disclosure.

FIG. 7 is a diagram illustrating detailed operations of a prioritization method for uplink transmission according to an embodiment of the disclosure.

FIG. 8 is a diagram illustrating detailed operations of a prioritization method for uplink PUCCH transmission according to an embodiment of the disclosure.

FIG. 9 is a diagram illustrating the difference in synchronization offset between base stations according to an embodiment of the disclosure.

FIG. 10 is a diagram illustrating a measurement and reporting operation of synchronization offset between base stations according to an embodiment of the disclosure.

FIG. 11 is a diagram illustrating the structure of a base station according to an embodiment of the disclosure.

FIG. 12 is a diagram illustrating the structure of a user equipment according to an embodiment of the disclosure.

### MODE FOR THE INVENTION

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

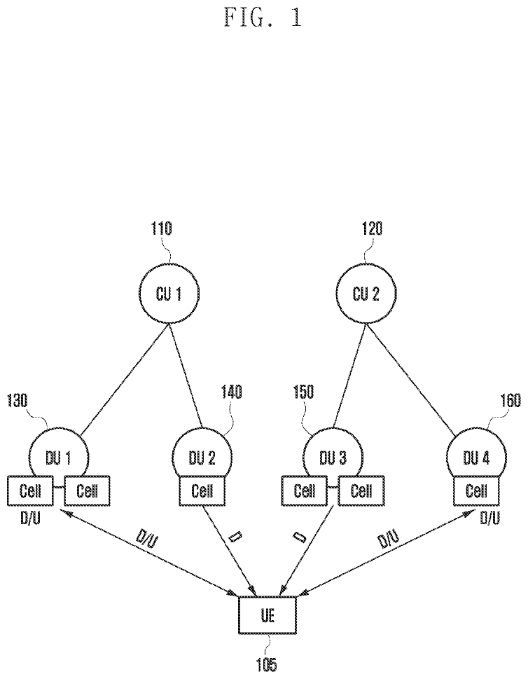

FIG. 1 is a diagram illustrating a base station connection method according to an embodiment of the disclosure.

Referring to FIG. 1, in a mobile communication system to which the disclosure may be applied, the functions of the base station may be implemented in a distributed manner, and may be composed of central units (CU) 110 and 120 in which higher layer functions are implemented and distributed units (DU) 130, 140, 150, and 160 in which lower layer functions are implemented. Based on the layer structure defined by the 3^{rd} Generation Partnership Project (3GPP), the functions of the radio resource control (RRC) layer, the service data adaptation protocol (SDAP) layer, and the packet data convergence protocol (PDCP) layer may be implemented in the CU, and the functions of the radio link control (RLC) layer, the medium access control (MAC) layer, and the physical (PHY) layer may be implemented in the DU. Because functions closely related to wireless transmission is implemented in the DU, the DU may be installed close to where the actual antennas are located. Accordingly, depending on the coverage of the DU base station, several DUs may be located in different places, and each DU may have one or more cells. A user equipment 105 may be connected to multiple cells using carrier aggregation technology, and the multiple cells connected to the user equipment may be cells of different DUs. In addition, in a dual connectivity or multi-connectivity structure, some of the multiple cells to which the user equipment is connected may be designated as one cell group.

The cell to which the user equipment is connected may be a cell only for downlink (D), or it may be a bidirectional (D/L) cell for both downlink and uplink. If the user equipment receives a downlink transmission, an uplink cell is required to transmit acknowledgement (ACK)/negative acknowledgment (NACK) feedbacks for the received downlink transmission. Because the ACK/NACK may be transmitted through a physical channel called the physical uplink control channel (PUCCH) in the physical layer, the ACK/NACK may also be called PUCCH transmission. On the other hand, an uplink cell is required to perform PUCCH transmission that occurs for a downlink cell of the user equipment, and for this purpose, each downlink cell may have a usable PUCCH uplink cell. This cell may be referred to as a PUCCH cell, and this PUCCH cell may be one of PCell, primary secondary cell (PSCell), or PUCCH secondary cell (PUCCH SCell). In the embodiment of FIG. 1, the user equipment 105 may be connected to multiple cells of four DUs 130, 140, 150, and 160. For example, DU1 and DU4 may each have one uplink cell among four DUs. This uplink cell may be a PUCCH cell. On the other hand, the uplink cell may be a cell that performs transmission through a physical channel called physical uplink shared channel (PUSCH).

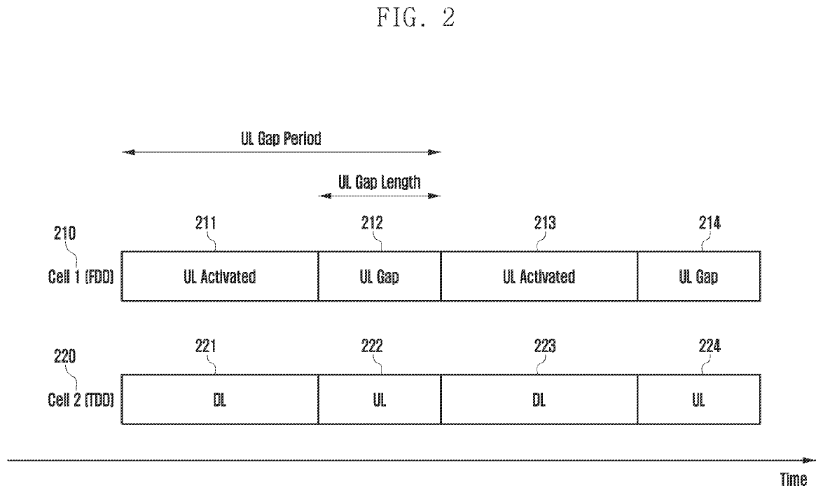

FIG. 2 is a diagram illustrating an uplink cell switching method according to an embodiment of the disclosure.

When a user equipment has multiple uplink cells, performing multiple uplink transmissions at the same time has the problem of reducing the coverage of uplink cells as the transmission power of the user equipment weakens because the user equipment's transmission power must be distributed and used for each cell transmission. To prevent this, when the user equipment is connected to multiple uplink cells, a method of limiting the number of uplink cells used at the time the user equipment actually performs transmission may be considered. In the embodiment of FIG. 2, it is assumed that a first cell 210 operating in a frequency division duplex (FDD) method and a second cell 220 operating in a time division duplex (TDD) method are configured. On the other hand, this is an example for convenience of explanation, but the disclosure is not limited thereto. According to the above assumption, performing uplink transmission of two cells at the same time has the problem of reduced coverage. To solve this problem, according to an embodiment of the disclosure, an uplink gap (UL Gap) in which uplink transmission is not performed may be configured in an uplink cell to perform one uplink transmission at onetime point (212, 214). Because the second cell, which is a TDD cell, may perform uplink transmission only at uplink transmission time point (222, 224), there are time points when uplink transmission must be performed periodically. On the other hand, when the first cell, which is an FDD cell, always performs uplink transmission, because the transmission time of the first cell overlaps with the uplink transmission of the second cell, it is necessary to limit the uplink transmission of the first cell at the overlapped time. To this end, the first cell may configure an uplink gap (212, 214) in which uplink transmission is not periodically performed, and at this time point (212, 214), uplink transmission of the first cell is stopped. In the embodiment of FIG. 2, it is assumed that the uplink gaps 212 and 214 of the first cell are configured to match the uplink transmission time points 222 and 224 of the second cell, but the uplink gaps do not necessarily have to match the uplink transmission time points and each cell may have uplink gaps independently depending on the needs of the base station. Because only uplink transmission is stopped during the uplink gap time, reception of downlink transmission may be continuously performed. On the other hand, in the disclosure, the uplink cell that does not perform uplink transmission during the uplink gap times 212 and 214 may be referred to as a deactivated uplink cell. In addition, in the disclosure, the uplink cell that performs uplink transmission at times 211 and 213 other than the uplink gap time may be referred to as an activated uplink cell. On the other hand, configurations related to the uplink gap may be configured by the base station to the user equipment through higher layer signaling (e.g., higher layer messages, radio resource control (RRC) signaling, and RRC messages), and in this case, the period and length of the uplink gap may be configured.

In the embodiment of FIG. 2, it is assumed that there is one activated uplink cell at one time point, but the number of uplink cells activated at one time point may vary depending on the capability of the user equipment and the policy of the base station.

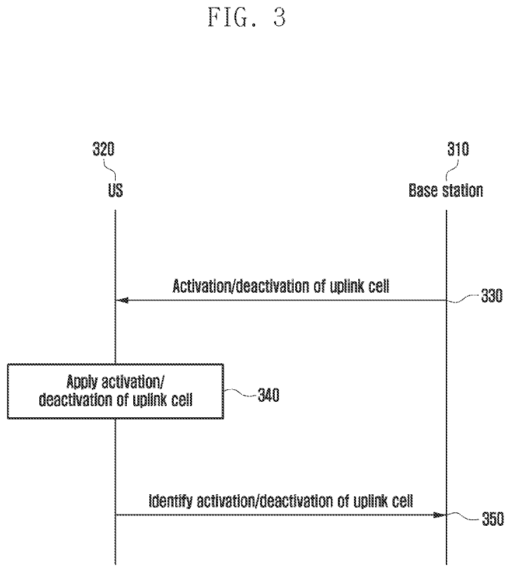

FIG. 3 is a diagram illustrating an activation method of an uplink cell according to an embodiment of the disclosure.

A base station may indicate the activation and deactivation of each uplink cell based on information related to a user equipment or a cell, such as the link quality of the user equipment or the congestion level of the cell. Based on this, the user equipment may differently configure which uplink cell to use for uplink transmission at each time. On the other hand, in the disclosure, activating or deactivating an uplink cell may refer to activating or deactivating the uplink of the uplink cell.

Referring to FIG. 3, the base station 310 may transmit a message, to the user equipment 320, indicating to activate or deactivate a specific uplink cell (330). The message indicating to activate or deactivate a specific uplink cell may have a downlink control information (DCI) format transmitted through the physical downlink control channel (PDCCH) or a MAC control element (CE) format of the medium access control (MAC) layer. This message 330 may include a field or information indicating whether to activate or deactivate the uplink of the uplink cell. In addition, according to one embodiment, the message 330 may include a bit value corresponding to each uplink cell in order to activate or deactivate the uplink of multiple uplink cells, and this bit value may correspond to activation or deactivation.

According to an embodiment, this uplink cell activation/deactivation message may activate or deactivate the uplink of the uplink cell in units of cell groups. In this case, the uplink of all uplink cells in a cell group may be activated or deactivated simultaneously. To this end, the message 330 may include a field or information indicating whether to activate or deactivate the uplink of the uplink cell group. In addition, according to an embodiment, in order to activate or deactivate the uplinks of multiple uplink cell groups, each cell group may have a bit value corresponding to activation or deactivation, and the bit value may correspond to activation or deactivation.

When the user equipment is indicated to activate or deactivate the uplink of a specific uplink cell (or uplink cell group), the user equipment may activate or deactivate the uplink of the uplink cell (or uplink cell group) as indicated (340). This activation or deactivation of such the uplink cell (or uplink cell group) may be actually applied after a predetermined time period from when the message in step 330 is received. In this case, it may be difficult for the base station to be sure whether the user equipment has correctly received the message in step 330, so the user equipment may transmit, to the base station, a message indicating that the user equipment has received (or received and applied the same) a message indicating activation or deactivation of the indicated uplink cell (or uplink cell group) (350).

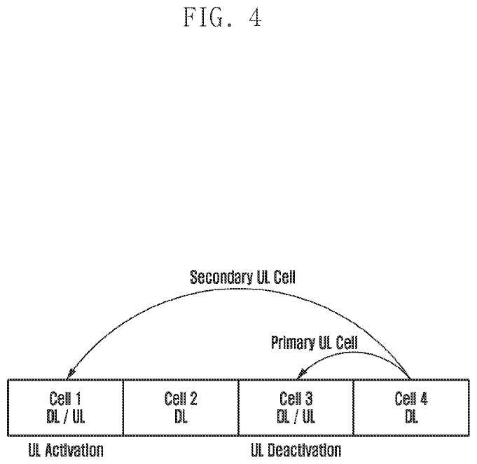

FIG. 4 is a diagram illustrating an activation method of an uplink cell according to an embodiment of the disclosure.

As described above, each downlink cell may have an uplink cell for transmitting ACK/NACK feedback for the received downlink transmission. If the uplink of this uplink cell is deactivated, uplink transmission to the deactivated cell cannot be performed. On the other hand, even in this case, multiple uplink cells may be configured for each cell so that the user equipment may continue to transmit uplink ACK/NACK feedback. In the embodiment of FIG. 4, it is illustrated that the user equipment has a total of 4 cells, which are cell 1, cell 2, cell 3, and cell 4, of which the primary uplink (UL) cell for cell 4 is configured to cell 3, and the secondary uplink (UL) cell for cell 4 is configured to cell 1. On the other hand, this is an example for convenience of explanation, but the disclosure is not limited thereto. In this case, when uplink transmission for cell 4 occurs and the uplink of the primary uplink cell is activated, the ACK/NACK feedback generated for cell 4 may be transmitted to cell 3, which is the primary uplink cell. On the other hand, deactivated cell 3 is illustrated in the embodiment of FIG. 4, and if the uplink of the primary uplink cell is deactivated like this, ACK/NACK feedback may be transmitted to cell 1, which is the secondary uplink cell. If the uplink of the secondary uplink cell is also deactivated, and if there is a next-order uplink cell, the next-order uplink cell may be used. On the other hand, if there is no uplink cell with activated uplink, ACK/NACK feedback may not be transmitted, or transmission may be suspended and waited until the uplink of the uplink cell is activated again.

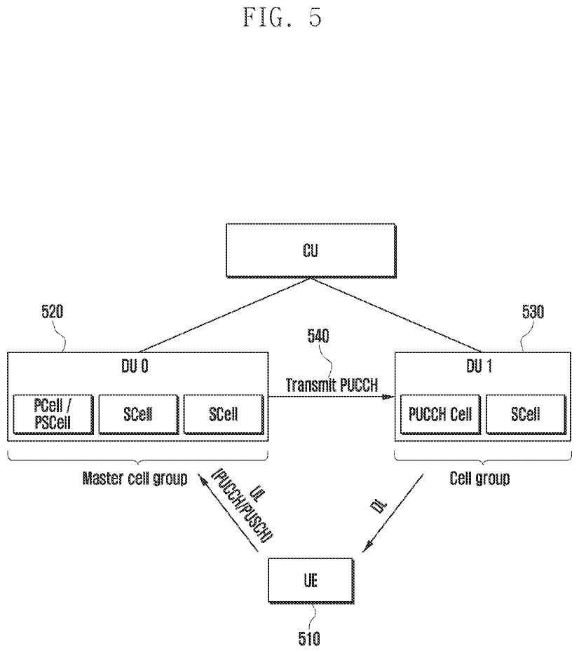

FIG. 5 is a diagram illustrating a transmission method between base stations for PUCCH transmission according to an embodiment of the disclosure.

When PUCCH transmission such as uplink ACK/NACK feedback for the cell of downlink transmission received by the user equipment is performed in a DU different from the DU on which the downlink transmission is performed, the DU that received the PUCCH transmission may need to forward the PUCCH transmission to the DU on which the downlink transmission is performed. On the other hand, PUCCH transmission may include at least one of a scheduling request message or a channel state indicator (CSI) feedback as well as the ACK/NACK feedback.

In the embodiment of FIG. 5, when the user equipment 510 must perform the corresponding PUCCH transmission (e.g., ACK/NAC feedback) after receiving the downlink transmission from DU1 530, but the PUCCH cannot be transmitted to DU1 530 because the uplink cell corresponding to the cell of DU1 is deactivated (that is, assuming that only the uplink of the uplink cell of DU 1 is deactivated), or when there is no uplink cell corresponding to DU1, PUCCH transmission may be performed by using an uplink cell corresponding to a cell of another DU (e.g., DU 0) 520. In this case, DU 0 520 which has received the PUCCH transmission for DU 1 530, may forward this PUCCH transmission to DU 1 530 because DU 0 520 does not need to use the PUCCH transmission. The network interface forwarding such PUCCH transmission may be transmitted in the form of a message transmitted and received through a newly defined or previously defined interface (e.g., Xn interface).

On the other hand, although FIG. 5 illustrates a case in which the functions of the base station are implemented separately into CU and DU, the disclosure is not limited thereto. For example, as illustrated in FIG. 5, when one or more different cells (or cell groups) are configured in the user equipment and the uplink cell (or cell group) corresponding to the cell (or cell group) in which downlink transmission was performed is deactivated, this embodiment may be applied by performing uplink transmission to an activated uplink cell of another cell group.

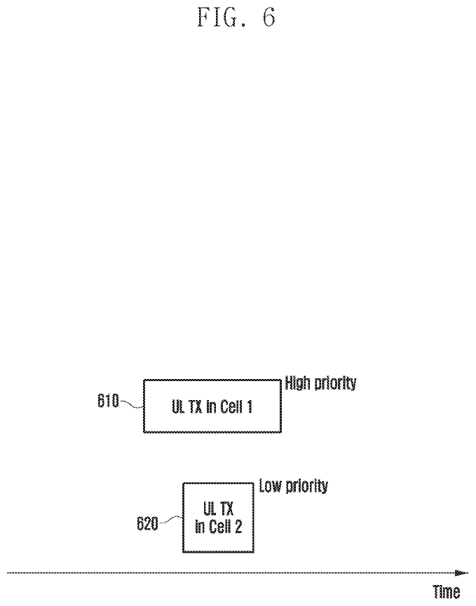

FIG. 6 is a diagram illustrating a prioritization method for uplink transmission according to an embodiment of the disclosure.

When the user equipment has a plurality of activated (usable) uplink cells, but the number of uplink cells that may be used at any one time point is limited, the user equipment may need to perform data transmission by selecting transmission of some uplink cells.

In FIG. 6, a situation is assumed in which uplink transmission is possible in two cells, cell 1 and cell 2, and the uplink transmission 610 of cell 1 and the uplink transmission 620 of cell 2 occur, but one of these uplink transmissions must be performed. In addition, in FIG. 6, it is assumed that cell 1 and cell 2 are located in the same cell group or different cell groups, uplink transmission of cell 1 and uplink transmission of cell 2 cannot occur at the same time by a configuration, but only uplink transmission of one cell is possible. On the other hand, this assumption is provided as an example for convenience of explanation, and the disclosure is not limited thereto. In this case, the user equipment may select transmission of a high-priority uplink cell and may only perform transmission of the selected uplink cell. The priority of these cells may be determined by a preconfigured method, and may also be determined by any one or a combination of some of the following examples.
Transmission of the master cell group may be prioritized over transmission of the secondary cell group.
Transmission of the PCell may be prioritized over transmission of other cells.
Transmission of the PSCell may be prioritized over transmission of other cells except the PCell.
Transmission with high priority indicated in the physical layer priority index (PHY priority index) may be prioritized.
Transmission of data in high priority logical channels may be prioritized based on the priority of the MAC laver logical channel.
Cells with a preconfigured high priority may be prioritized. The priority of a preconfigured cell may be the cell's index value.
PUCCH transmission may be prioritized over PUSCH transmission.

The embodiment of FIG. 6 illustrates a case where the uplink transmission 610 configured in cell 1 has a higher priority than the uplink transmission 620 configured in cell 2 and is prioritized. Accordingly, uplink transmission of cell 1 may be performed, but uplink transmission of cell 2 may not be performed. In this way, the operation of selecting one cell according to the priority may be performed for each group of preconfigured uplink cells. On the other hand, the group of uplink cells considered in an operation of selecting one cell according to priority may be different from a typical cell group. For example, in the embodiment of FIG. 6, it is assumed that cell 1 and cell 2 are configured as one group, and if there is cell 3, which is another uplink cell that does not belong to this group, uplink transmission transmitted from cell 3 may not go through this prioritization process. According to an embodiment, when a group of uplink cells is configured, and N simultaneous transmissions are allowed among these uplink cell groups, transmission of N high priority uplink cells may be selected. For example, when a group of uplink cells including cell 1, cell 2, and cell 3 is configured, two simultaneous transmissions are allowed among the corresponding uplink cell groups, transmission of two uplink cells may be selected and performed in a high order according to priority.

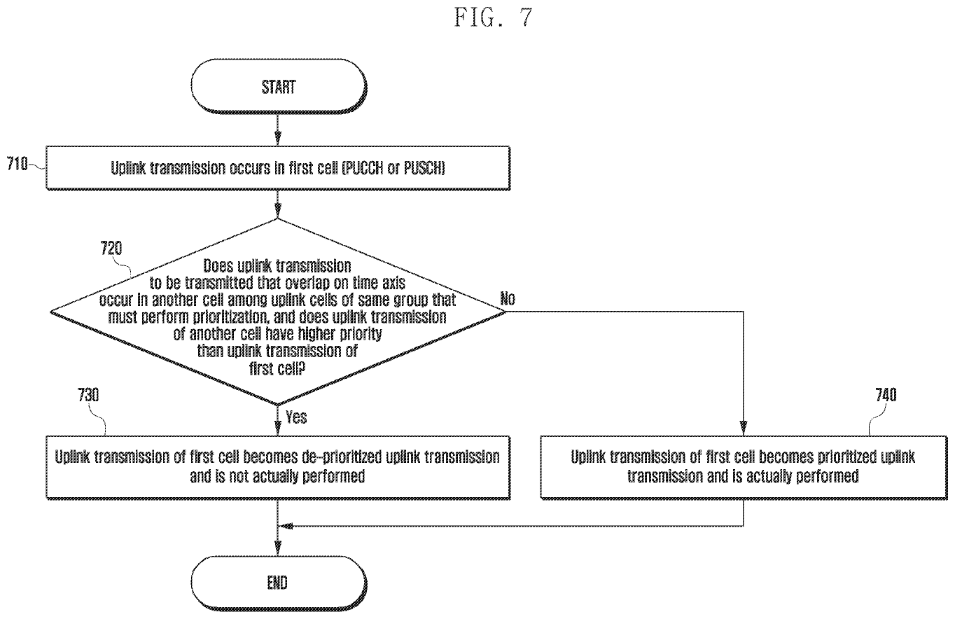

FIG. 7 is a diagram illustrating detailed operations of a prioritization method for uplink transmission according to an embodiment of the disclosure.

As described above, performing multiple uplink transmissions simultaneously may lower the transmission power of the user equipment, so the number of uplink transmissions performed at onetime point may be limited. The embodiment of FIG. 7 illustrates an embodiment in which only one uplink transmission is allowed at the same time point in one uplink cell group.

If uplink transmission has occurred in the first cell, which is the uplink cell configured in the user equipment, it may be identified (710). Here, the uplink transmission of the user equipment may be PUCCH transmission or PUSCH transmission. On the other hand, in order for the user equipment to actually perform the generated uplink transmission, it is necessary to identify whether high priority uplink transmission occurred while overlapping with other cells in the configured uplink cell group on the time axis. In other words, it may be identified that an uplink transmission to be transmitted that overlaps on the time axis occurred in another cell among the uplink cells of the same group that must perform prioritization, and whether the uplink transmission of another cell has a higher priority than the uplink transmission of the first cell (720). Here, whether the uplink cell has high priority may be determined by a preconfigured method, and may also be determined by any one or a combination of some of the following examples.
Transmission of the master cell group may be prioritized over transmission of the secondary cell group.
Transmission of the PCell may be prioritized over transmission of other cells.
Transmission of the PSCell may be prioritized over transmission of other cells except the PCell.
Transmission with high priority indicated in the physical layer priority index (PHY priority index) may be prioritized.
Transmission of data in high priority logical channels may be prioritized based on the priority of the MAC layer logical channel.
Cells with a preconfigured high priority may be prioritized. The priority of a preconfigured cell may be the cell's index value.
PUCCH transmission may be prioritized over PUSCH transmission.

When the conditions of step 720 are satisfied, this may refer to that uplink transmission of another cell must be performed within the same uplink cell group. Accordingly, the uplink transmission of the first cell becomes a de-prioritized uplink transmission and may not be actually transmitted (730). This refers to that uplink transmission of another cell becomes prioritized transmission and is actually performed. If the conditions of step 720 are not satisfied, this refers to that uplink transmission of the first cell may be performed. In other words, the uplink transmission of the first cell becomes a prioritized uplink transmission and may be actually performed (740). In this case, uplink transmission of another cell within the same uplink cell group that overlaps with the first cell on the time axis may be de-prioritized uplink transmission.

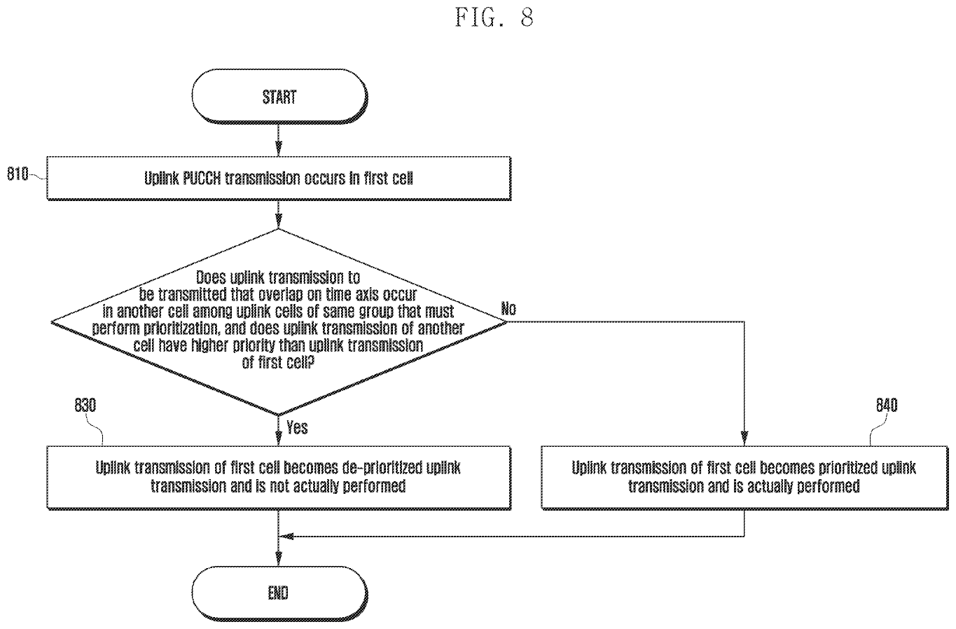

FIG. 8 is a diagram illustrating detailed operations of a prioritization method for uplink PUCCH transmission according to an embodiment of the disclosure.

As described above, performing multiple uplink transmissions simultaneously may lower the transmission power of the user equipment, so the number of uplink transmissions performed at one time point may be limited for PUCCH transmission requiring high stability. The embodiment of FIG. 8 illustrates an embodiment in which only one uplink PUCCH transmission is allowed at the same time point in one uplink cell group.

If uplink PUCCH transmission has occurred in the first cell, which is the uplink cell configured in the user equipment, it may be identified (810). Here, in order for the user equipment to actually perform the generated uplink PUCCH transmission, it is necessary to identify whether high priority uplink transmission occurred while overlapping with other cells in the configured uplink cell group on the time axis. In other words, it may be identified that an uplink PUCCH transmission to be transmitted that overlaps on the time axis occurred in another cell among the uplink cells of the same group that must perform prioritization, and whether the uplink PUCCH transmission of another cell has a higher priority than the uplink PUCCH transmission of the first cell (820). Here, whether the uplink cell has high priority may be determined by a preconfigured method, and may also be determined by any one or a combination of some of the following examples.
Transmission of the master cell group may be prioritized over transmission of the secondary cell group.
Transmission of the PCell may be prioritized over transmission of other cells.
Transmission of the PSCell may be prioritized over transmission of other cells except the PCell.
Transmission with high priority indicated in the physical layer priority index (PHY priority index) may be prioritized.
Cells with a preconfigured high priority may be prioritized. The priority of a preconfigured cell may be the cell's index value.

When the conditions of step 820 are satisfied, this may refer to that uplink PUCCH transmission of another cell must be performed within the same uplink cell group. Accordingly, the uplink PUCCH transmission of the first cell becomes a de-prioritized uplink transmission and may not be actually transmitted (830). This refers to that uplink PUCCH transmission of another cell becomes prioritized transmission. In addition, in this case. PUSCH transmission of the first cell may not be performed. If the conditions of step 820 are not satisfied, this refers to that uplink PUCCH transmission of the first cell may be performed. In other words, the uplink PUCCH transmission of the first cell becomes a prioritized uplink transmission and may be actually performed (840). In this case, uplink PUCCH transmission of another cell within the same uplink cell group that overlaps with the first cell on the time axis may be de-prioritized uplink transmission and may not actually be performed. In addition, uplink PUSCH transmission of another cell that overlaps on the time axis with the first cell in the group may not be performed.

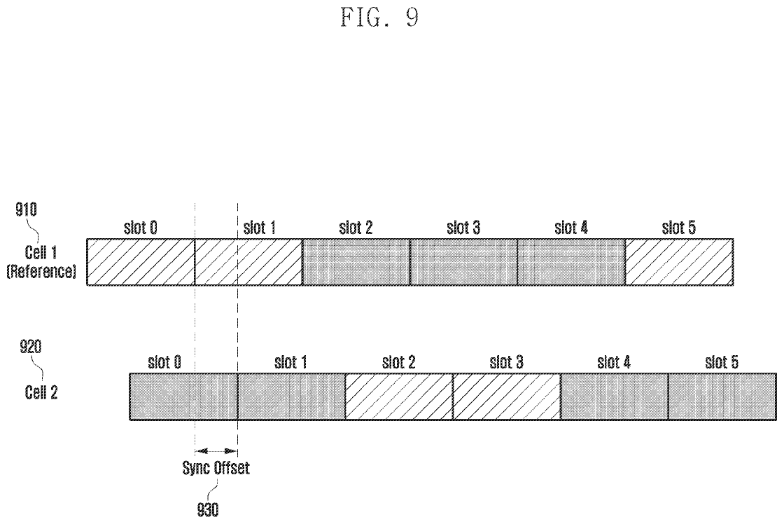

FIG. 9 is a diagram illustrating the difference in synchronization offset between base stations according to an embodiment of the disclosure.

When a user equipment is connected to cells of multiple DUs, the boundaries of frames or slots between different DUs may not match. That is, frame synchronization or slot synchronization between DUs may not match. In addition, even within the same DU, errors in modules within the base station may occur, so frame synchronization or slot synchronization may not match.

In the embodiment of FIG. 9, it is assumed that there are two cells (according to one embodiment, the same may be applied to a cell group) 910 and 920. However, the slot boundary timing of these cells may be different. The base station may need to know the difference in synchronization between cells from the user equipment's perspective in order to limit the number of simultaneously transmitted uplink transmissions as described above. To this end, the user equipment may need to measure the time difference in slot synchronization (or frame synchronization) between each cell (or, cell group, or timing advance group (TAG)) based on the user equipment's uplink (or downlink). In the embodiment of FIG. 9, a synchronization offset 930 of cell 2 is illustrated based on cell 1, which is a reference cell. This time difference may be measured and reported to the base station, so that the base station may use the same to adjust the number of uplinks at the same time point. For example, in the embodiment of FIG. 9, considering the synchronization offset of the user equipment, slot 0 and slot 1 of cell 1 may be used for uplink transmission of cell 1, slot 2 and slot 3 of cell 2 may be used for uplink transmission of cell 2, and again, slot 5 of cell 1 may be used for uplink transmission of cell 1. On the other hand, as illustrated in FIG. 9, slot 4 of cell 1 overlaps with slot 3 of cell 2 on the time axis, so slot 4 of cell 1 may not be used for uplink transmission. On the other hand, according to an embodiment, the above-described reference cell may be a PCell.

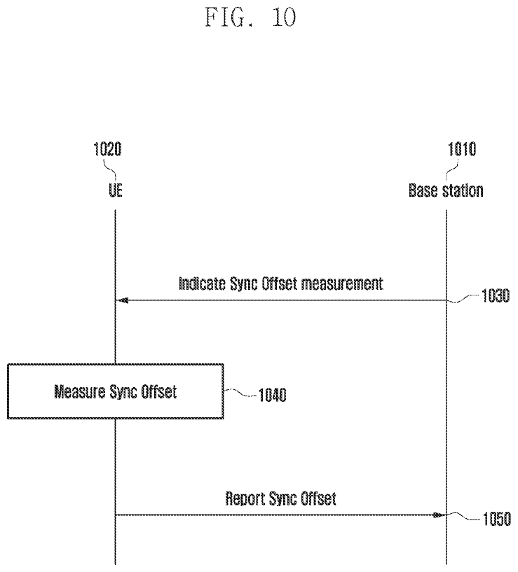

FIG. 10 is a diagram illustrating a measurement and reporting operation of synchronization offset between base stations according to an embodiment of the disclosure.

When a user equipment is connected to cells of multiple DUs, the boundaries of frames or slots between different DUs may not match. That is, frame synchronization or slot synchronization between DUs may not match. In addition, even within the same DU, errors in modules within the base station may occur, so frame synchronization or slot synchronization may not match. Because the slot boundary timing of these cells may be different, the base station may need to know the difference in synchronization between cells from the user equipment's perspective in order to limit the number of simultaneously transmitted uplink transmissions as described above. To this end, the user equipment may need to measure the time difference in slot synchronization (or frame synchronization) between each cell (or, cell group, or timing advance group (TAG)) based on the user equipment's uplink (or downlink).

If the base station 1010 needs to know the difference in uplink synchronization between cells (or cell groups) of the user equipment 1020, the base station may indicate the user equipment to measure the synchronization offset (1030). This message may include at least one of the following information.
Which synchronization offset of cell or cell group to measure
Whether to measure uplink offset, downlink offset, or all
Whether to report uplink offset, downlink offset, or all
Which cell is the reference cell (or reference cell group)
When to report the synchronization offset

Based on the information in the message in step 1030, the user equipment may then measure the synchronization offset (1040). The synchronization offset may be the difference of a slot or frame boundary point with the reference cell, as illustrated in the embodiment of FIG. 9. Thereafter, at a time when the user equipment needs to report the synchronization offset, the user equipment may report the synchronization offset value to the base station (1050). In this case, the user equipment may report only the uplink synchronization offset, only the downlink synchronization offset, or both the uplink synchronization offset and the downlink synchronization offset. Based on this, the base station may indicate uplink activation and deactivation of the uplink cell configured in the user equipment. On the other hand, the uplink activation and deactivation of the uplink cell here may be as described in FIGS. 3 to 4, or may be the uplink gap configuration described in FIG. 2.

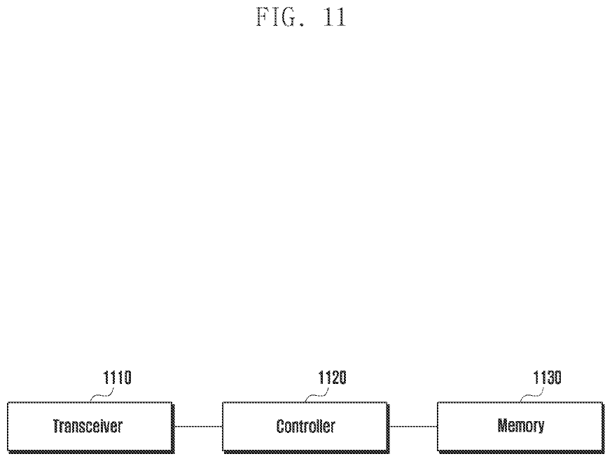

FIG. 11 is a diagram illustrating the structure of a base station according to an embodiment of the disclosure.

Referring to FIG. 11, the base station may include a transceiver 1110, a controller 1120, and a memory 1130. In the disclosure, the controller 1120 may be defined as a circuit, an application-specific integrated circuit, or at least one processor. The transceiver unit 1110 may transmit and receive signals with other network entities. For example, the transceiver 1110 may transmit system information to the user equipment and transmit a synchronization signal or a reference signal. The controller 1120 may control the overall operation of the base station according to the embodiment proposed in the disclosure. For example, the controller 1120 may control signal flow between each block to perform operations according to the flowchart described above. The memory 1130 may store at least one of information transmitted and received through the transceiver 1110 and information generated through the controller 1120.

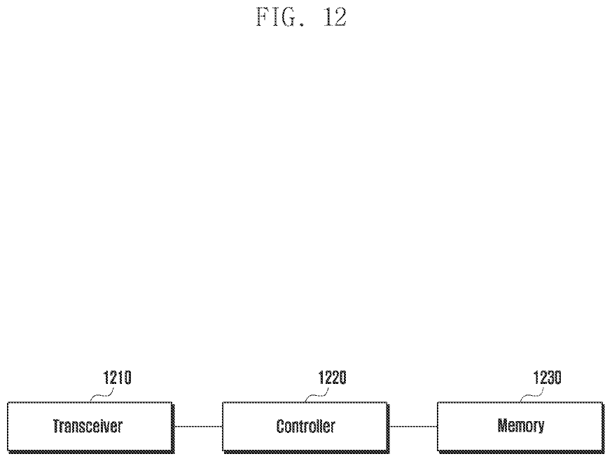

FIG. 12 is a diagram illustrating the structure of a user equipment according to an embodiment of the disclosure.

Referring to FIG. 12, the user equipment may include a transceiver 1210, a controller 1220, and a memory 1230. In the disclosure, the controller 1220 may be defined as a circuit, an application-specific integrated circuit, or at least one processor. The transceiver unit 1210 may transmit and receive signals with other network entities. For example, the transceiver 1210 may receive system information from the base station and receive a synchronization signal or a reference signal. The controller 1220 may control the overall operation of the user equipment according to the embodiment proposed in the disclosure. For example, the controller 1220 may control signal flow between each block to perform operations according to the flowchart described above. The memory 1230 may store at least one of information transmitted and received through the transceiver 1210 and information generated through the controller 1220.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein. The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet. Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal.

In the drawings in which methods of the disclosure are described, the order of the description does not always correspond to the order in which steps of each method are performed, and the order relationship between the steps may be changed or the steps may be performed in parallel. Alternatively, in the drawings in which methods of the disclosure are described, some elements may be omitted and only some elements may be included therein without departing from the essential spirit and scope of the disclosure.

Furthermore, in the methods of the disclosure, a part or all of the contents of each embodiment may be combined without departing from the essential spirit and scope of the disclosure.

Various embodiments of the disclosure have been described above. The above description of the disclosure is merely for the purpose of illustration, and embodiments of the disclosure are not limited to the embodiments set forth herein. Those skilled in the art will appreciate that other particular modifications and changes may be easily made without departing from the technical idea or the essential features of the disclosure. The scope of the disclosure is determined not by the above detailed description but by the appended claims, and all modifications or changes derived from the meaning and scope of the claims and equivalent concepts thereof shall be construed as falling within the scope of the disclosure.

1. A method performed by a user equipment in a communication system, the method comprising:
receiving, from a base station, first information indicating activation or deactivation of at least one uplink cell of a first cell group;
transmitting, to the base station, second information indicating that the first information is received;
identifying, based on the first information, whether a first uplink cell among the at least one uplink cell is activated; and
performing an uplink transmission through the first uplink cell in case that the first uplink cell is activated.

2. The method of claim 1, wherein the first information comprises at least one bit,
wherein the at least one bit respectively corresponds to the at least one uplink cell, and
wherein each of the at least one bit indicates activation or deactivation of the corresponding uplink cell.

3. The method of claim 1, wherein the identifying of whether the first uplink cell is activated comprises:
identifying a primary uplink cell corresponding to a downlink cell on which downlink reception is performed among the at least one uplink cell of the first group;
identifying whether the primary uplink cell is activated;
identifying a secondary uplink cell corresponding to the downlink cell in case that the primary uplink cell is deactivated; and
identifying whether the secondary uplink cell is activated.

4. The method of claim 1, further comprising:
identifying whether a second uplink cell is activated among at least one uplink cell of a second group in case that the at least one uplink cell of the first cell group is deactivated; and
performing the uplink transmission through the second uplink cell in case that the second uplink cell is activated.

5. The method of claim 1, further comprising:
identifying whether the uplink transmission for the first uplink cell and the uplink transmission for a third uplink cell overlap;
identifying priorities of the uplink transmission for the first uplink cell and the uplink transmission for the third uplink cell in case that the uplink transmission for the first uplink cell and the uplink transmission for the third uplink cell overlap;
identifying higher priority uplink transmission among the uplink transmission for the first uplink cell and the uplink transmission for the third uplink cell, based on the priority; and
performing the higher priority uplink transmission.

6. The method of claim 5, wherein the priority is determined based on at least one of:
whether a cell belongs to a master cell group;
whether a cell is a primary cell (PCell);
a physical layer priority index related to uplink transmission for a cell;
a priority of a logical channel of the medium access control (MAC) layer related to uplink transmission for a cell;
whether an uplink transmission for a cell is a physical uplink control channel (PUCCH) transmission or a physical uplink shared channel (PUSCH) transmission; or
an index of a cell.

7. A method performed by a base station in a communication system, the method comprising:
transmitting, to a user equipment, first information indicating activation or deactivation of at least one uplink cell of a first cell group; and
receiving, from the user equipment, second information indicating that the first information is received,
wherein whether a first uplink cell among the at least one uplink cell is activated is identified based on the first information, and
wherein an uplink reception is performed through the first uplink cell in case that the first uplink cell is activated.

8. The method of claim 7, wherein the first information comprises at least one bit,
wherein the at least one bit respectively corresponds to the at least one uplink cell, and
wherein each of the at least one bit indicates activation or deactivation of the corresponding uplink cell.

9. A user equipment in a communication system, comprising:
a transceiver; and
a controller connected to the transceiver,
wherein the controller is configured to:
receive, from a base station, first information indicating activation or deactivation of at least one uplink cell of a first cell group;
transmit, to the base station, second information indicating that the first information is received;
identify, based on the first information, whether a first uplink cell among the at least one uplink cell is activated; and
perform an uplink transmission through the first uplink cell in case that the first uplink cell is activated.

10. The user equipment of claim 9, wherein the first information comprises at least one bit,
wherein the at least one bit respectively corresponds to the at least one uplink cell, and
wherein each of the at least one bit indicates activation or deactivation of the corresponding uplink cell.

11. The user equipment of claim 9, wherein the controller is configured to:
identify a primary uplink cell corresponding to a downlink cell on which downlink reception is performed among the at least one uplink cell of the first group;
identify whether the primary uplink cell is activated;
identify a secondary uplink cell corresponding to the downlink cell in case that the primary uplink cell is deactivated; and
identify whether the secondary uplink cell is activated.

12. The user equipment of claim 9, wherein the controller is configured to:
identify whether a second uplink cell is activated among at least one uplink cell of a second group in case that the at least one uplink cell of the first cell group is deactivated; and
perform the uplink transmission through the second uplink cell in case that the second uplink cell is activated.

13. The user equipment of claim 9, wherein the controller is configured to:
identify whether the uplink transmission for the first uplink cell and the uplink transmission for a third uplink cell overlap;
identify priorities of the uplink transmission for the first uplink cell and the uplink transmission for the third uplink cell in case that the uplink transmission for the first uplink cell and the uplink transmission for the third uplink cell overlap;
identify higher priority uplink transmission among the uplink transmission for the first uplink cell and the uplink transmission for the third uplink cell, based on the priority; and
perform the higher priority uplink transmission, and
wherein the priority is determined based on at least one of:
whether a cell belongs to a master cell group;
whether a cell is a primary cell (PCell);
a physical layer priority index related to uplink transmission for a cell;
a priority of a logical channel of the medium access control (MAC) layer related to uplink transmission for a cell;
whether an uplink transmission for a cell is a physical uplink control channel (PUCCH) transmission or a physical uplink shared channel (PUSCH) transmission; or
an index of a cell.

14. A base station in a communication system, comprising:
a transceiver; and
a controller connected to the transceiver,
wherein the controller is configured to:
transmit, to a user equipment, first information indicating activation or deactivation of at least one uplink cell of a first cell group; and
receive, from the user equipment, second information indicating that the first information is received,
wherein whether a first uplink cell among the at least one uplink cell is activated is identified based on the first information, and
wherein an uplink reception is performed through the first uplink cell in case that the first uplink cell is activated.

15. The base station of claim 14, wherein the first information comprises at least one bit,
wherein the at least one bit respectively corresponds to the at least one uplink cell, and
wherein each of the at least one bit indicates activation or deactivation of the corresponding uplink cell.
